(19) United States
(12) Patent Application Publication
(10) Pub. No.: US 2009/0282176 A1
(43) Pub. Date: Nov. 12, 2009

(54) COMPUTER SYSTEM AND METHOD FOR PROCESSING DATA SIGNAL OF MEMORY INTERFACE THEREOF

(75) Inventor: Ting-Kuo Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/407,790

(22) Filed: Mar. 20, 2009

(30) Foreign Application Priority Data
May 9, 2008 (TW) 97117173

(51) Int. Cl. G06F 12/00; G06F 13/16

(52) U.S. Cl. 710/104; 711/154; 711/E12.001

(57) ABSTRACT

A computer system and a method for processing a data signal of a memory interface thereof are provided. The computer system includes a memory module, a memory controller, and a digital signal processor. The memory controller accesses data temporarily stored in the memory module through a data bus. The digital signal processor processes varied data on the bus according to a select code to recover the data.

### CROSS-REFERENCE TO RELATED APPLICATION

This application claims the priority benefit of Taiwan application serial no. 97117173, filed on May 9, 2008. The entirety of the above-mentioned patent application is hereby incorporated by reference herein and made a part of this specification.

### BACKGROUND OF THE INVENTION

1. Field of the Invention

The invention relates to a method for processing a data signal of a memory interface and, more particularly, to a computer system and a method for processing a data signal of a memory interface thereof.

2. Description of the Related Art

In recent years, with the development of manufacturing techniques of the semiconductor, the manufacture process of the central processing unit (CPU) progresses from a deep sub-micron process to a nanometer process. Therefore, not only the functions of the CPU increase, but the operating frequency of the CPU also should be higher, which contributes to improve the overall operating performance of the computer system. To successfully improve the overall operating performance of the computer system, a memory module is generally used to assist the CPU to provide data temporarily stored therein.

However, generally, data are transferred between the memory module and a memory controller (which is often built in a north bridge chip) controlling the access of the memory module via a data bus composed of copper traces on a printed circuit board (PCB) directly. Therefore, under the influence of the parasitic effects (such as parasitic inductance, parasitic capacitance) of the copper traces, when the CPU executes high-speed data transfer, the transferred data on the data bus may have variations such as serious attenuation and phase shifts.

The above problem not only makes the memory controller fail to determine the accuracy of the data stored in the memory module, but it also makes the data which the memory controller wants to write to the memory module have errors. Therefore, to effectively restrain the unreasonable variations of the data transferred on the data bus, unavoidably, the operating frequency of the CPU should be a reasonable value in a reasonable range. Thereby, the state of variations is moderated. However, the overclocking range of the memory controller is greatly limited, which restrains the improvement extent of the overall operating performance of the computer system.

### BRIEF SUMMARY OF THE INVENTION

The invention provides a computer system and a method for processing a data signal of a memory interface thereof to improve the prior art.

The invention provides a computer system. The computer system includes a memory module, a memory controller, and a digital signal processor. The digital signal processor is coupled with the memory module and the memory controller, respectively. The digital signal processor is located on a data transfer route between the memory controller and the memory module, and the digital signal processor is used to process signals outputted from the memory controller according to a work mode that a select code corresponds to.

In another aspect, the invention provides a method for processing a data signal of a memory interface. The method for processing the data signal is adapted for the data signal between the memory controller and the memory module. The method for processing the data signal includes the steps of receiving an attenuated data signal resulting from the attenuation of a first data signal outputted from the memory controller, processing the attenuated data signal according to a work mode to which a select code corresponds to obtain a second data signal, and transmitting the second data signal to the memory module.

The invention has beneficial effects. In the embodiment of the invention, the digital signal processor is connected to a transfer route of a data bus in series between the memory controller and the memory module. Thereby the digital signal processor remedies the varied data transferred on the data transfer route to recover the data. Therefore, the computer system provided in the embodiment of the invention can make the overclocking range of the memory controller and the improvement extent of the overall performance of the computer system thereof unlimited.

These and other features and advantages of the present invention will become better understood with regard to the following description, appended claims, and accompanying drawings.

### BRIEF DESCRIPTION OF THE DRAWINGS

FIG. 1 is a block diagram of a computer system according to a first embodiment of the invention.

FIG. 2 is a block diagram of a computer system according to a second embodiment of the invention.

FIG. 3 is a flowchart of a method for processing a data signal of a memory interface according to a preferred embodiment of the invention.

### DETAILED DESCRIPTION OF THE EMBODIMENTS

A technical effect of a preferred embodiment of the invention is solving the influence of the parasitic effect of the copper traces on the motherboard of a computer system on a data transfer. Another is increasing the overclocking range of a memory controller and the overall performance of the computer system that the memory controller is adapted for. Features of a preferred embodiment of the invention are described in detail hereinbelow for people having ordinary skills in the art to refer to.

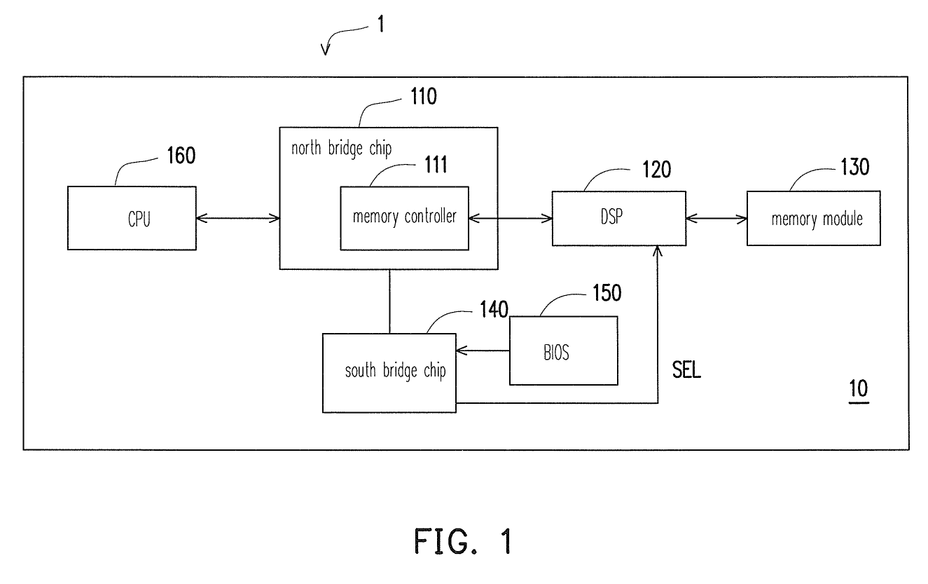

FIG. 1 is a block diagram of a computer system according to a first embodiment of the invention. As shown in FIG. 1, the embodiment provides a computer system 1 including a motherboard 10, a north bridge chip 110, a digital signal processor 120, a memory module 130, a south bridge chip 140, a basic input output system (BIOS) 150, and a central processing unit (CPU) 160.

In the embodiment, a memory controller 111 is built in the north bridge chip 110. In other embodiments, the memory controller 111 may be integrated in the CPU 160 of the computer system 1. In other embodiments, the north bridge chip 110 also may be integrated in the CPU 160 of the computer system 1, and the memory controller 111 also may be integrated in the CPU 160.

The north bridge chip 110 is coupled with the digital signal processor 120, the south bridge chip 140, and the CPU 160, respectively. The memory controller 111 in the north bridge chip 110 is coupled with the digital signal processor 120 and the memory module 130. The digital signal processor 120 is further coupled with the memory module 130 and the south bridge chip 140, respectively. The south bridge chip 140 is also coupled with the BIOS 150.

The BIOS 150 is a non-volatile memory. The BIOS 150 stores BIOS program codes of the computer system 1. The BIOS program codes of the BIOS 150 may be used to adjust the operating frequency of the CPU 160 in the embodiment, and this action is commonly called as overclocking. Furthermore, the BIOS 150 may record the adjusted operating frequency of the CPU 160.

The south bridge chip 140 can read the operating frequency of the CPU 160 stored in the BIOS 150. The south bridge chip 140 generates a select code SEL according to the read operating frequency and transmits it to the digital signal processor 120 through a general purpose input output (GPIO) system.

In the embodiment, the south bridge chip 140 generates the select code SEL via a look-up table. For example, the south bridge chip 140 reads that the operating frequency of the CPU 160 is 1 GHz, and then the south bridge chip 140 utilizes a built-in table (the table may be stored in the BIOS 150) to inquire the select code SEL that the operating frequency 1 GHz corresponds to. The select code SEL is, for example, “000”. If the operating frequency of the CPU 160 is 1.5 GHz, the select code SEL is “001”. Thereby, the south bridge chip 140 can generate the select code SEL according to the read operating frequency of the CPU 160 and then send the select code SEL to the digital signal processor 120.

The digital signal processor 120 has a compensation module. The compensation module may be realized by hardware means or software means. In the embodiment, the compensation module is realized by software means. The compensation module has a plurality of work modes. Each work mode corresponds to a select code SEL. That is, when the digital signal processor 120 receives different select codes SEL, it changes the work mode of the compensation module according to the received select code SEL, and it processes signals in the work mode that the received select code SEL corresponds to.

In the embodiment, the select code SEL includes three bits. In other embodiments, the select code SEL may include one or two bits. The number of bits is relevant to a plurality of work modes of the compensation module.

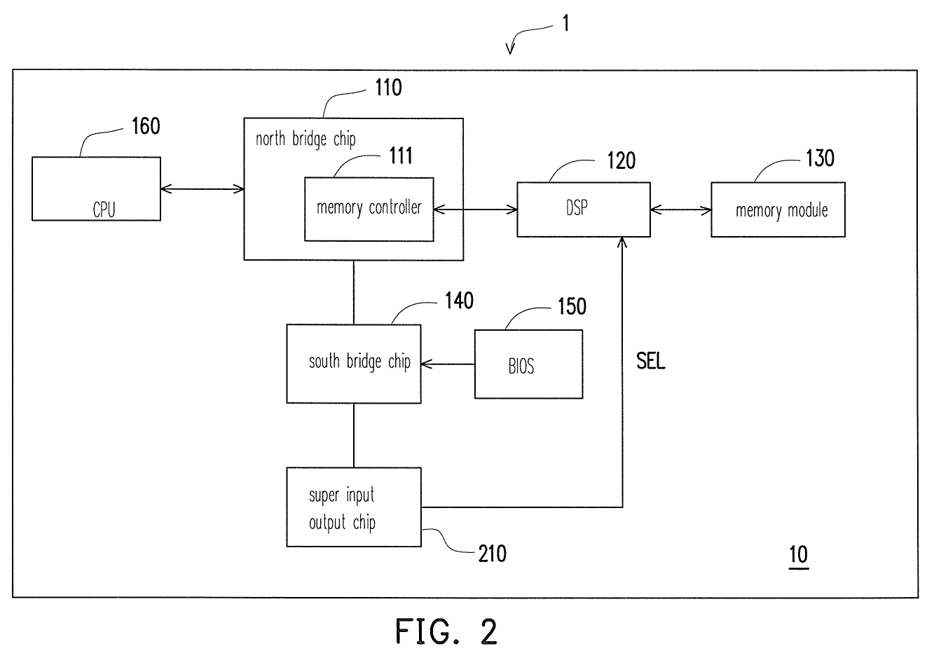

FIG. 2 is a block diagram of a computer system according to a second embodiment of the invention. In the embodiment, the computer system 1 includes a motherboard 10, a north bridge chip 110, a digital signal processor (DSP) 120, a memory module 130, a south bridge chip 140, a BIOS 150, a CPU 160 and a super input output chip 210.

The elements and functional blocks provided in the embodiment are similar to the elements and functional blocks in the first embodiment. The embodiment further provides the super input output chip 210 coupled with the south bridge chip 140 and the digital signal processor 120, respectively. In the first embodiment, the work mode of the compensation module of the digital signal processor 120 is controlled by the south bridge chip 140. In the second embodiment, the work mode of the compensation module of the digital signal processor 120 is controlled by the super input output chip 210.

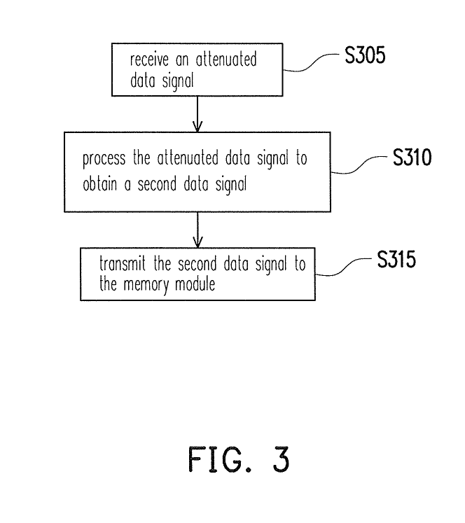

FIG. 3 is a flowchart of a method for processing a data signal of a memory interface according to a preferred embodiment of the invention. As shown in FIG. 1 and FIG. 3, in the computer system 1, the memory controller 111 may be one of the most important elements of the motherboard 10 or the whole computer system 1. The memory controller 111 is used to monitor the data input and output from the memory module 130. Furthermore, in some embodiments, the memory controller 111 can further verify the integration of the data.

In the embodiment, the memory interface includes the memory controller 111 and the memory module 130. By the method for processing a data signal in the embodiment, the data signal between the memory controller 111 and the memory module 130 can be processed.

When the memory controller 111 transmits the data signal to the memory module 130, or when the memory controller 111 reads data from the memory module 130, the data signal transmitted from the memory module 130 to the memory controller 111 may attenuate under the influence of the data bus (such as copper foils) on the motherboard 10. In the embodiment, for example, when the memory controller 111 transmits data signals to the memory module 130, the data signals are recovered, and the recovered data signals are transmitted to the memory module 130.

In step S305, the memory controller 111 transmits a first data signal to the memory module 130. The first data signal attenuates in the process of transmitting the data signal on the data bus of the motherboard 10. Therefore, the digital signal processor 120 disposed on a data transfer route between the memory controller 111 and the memory module 130 receives an attenuated data signal. The attenuated data signal results from the first data signal outputted from the memory controller 111.

In step S305, the digital signal processor 120 selects the work mode of the compensation module according to the select code SEL outputted from the south bridge chip 140 or the super input output chip (in other embodiments). For example, when the operating frequency of the CPU is 1.5 GHz, the select code SEL is “001”. The digital signal processor 120 selects the corresponding work mode of the compensation module according to the select code SEL.

Then, after the digital signal processor 120 receives the attenuated data signal, the digital signal processor 120 processes the attenuated data signal according to the work mode to which the select code SEL (“001”) corresponds to obtain a second data signal. For example, the digital signal processor 120 recovers the attenuated data signal. In the embodiment, the parameters such as the waveform, the frequency, the phase of the second data signal are essentially equal to the parameters of the first data signal outputted from the memory controller 111.

In the embodiment, the method for processing the signal of the digital signal processor 120 is described hereinbelow. First, after the digital signal processor 120 receives the attenuated data signal, the digital signal processor 120 utilizes its analogy digital converter to sample the attenuated data signal and digitalize the attenuated data signal. Then, the digital signal processor 120 converts the sampled digital data to the frequency domain, and it selects an appropriate work mode to recover the received varied data. At last, the digital signal processor 120 converts these data to the time domain and transmits these converted data to the memory module 130.

In step S305, the digital signal processor 120 transmits the second data signal to the memory module 130.

Furthermore, if the operating frequency of the CPU 160 is changed (that is, the CPU 160 is overclocked), the BIOS 150 stores the changed operating frequency. As described in aforementioned illustration, the south bridge chip 140 reads a new operating frequency from the BIOS 150 and generates a new select code SEL to send it to the digital signal processor 120. That is, even when the operating frequency of the CPU 160 is adjusted dynamically, the digital signal processor 120 for compensating the varied data correspondingly adjusts the work mode to produce the compensation effect.

To sum up, the invention utilizes the digital signal processor to remedy and recover the data of the data bus between the memory module and the memory controller. The digital signal processor coordinates with the operating frequency of the CPU dynamically to adjust corresponding built-in compensation programs, which ensures that the computer system and the motherboard operate normally under a plurality of different operating frequencies to improve the work performance.

Although the present invention has been described in considerable detail with reference to certain preferred embodiments thereof, the disclosure is not for limiting the scope of the invention. Persons having ordinary skill in the art may make various modifications and changes without departing from the scope and sprit of the invention. Therefore, the scope of the appended claims should not be limited to the description of the preferred embodiments described above.

What is claimed is:

1. A computer system comprising:
a memory module;
a memory controller; and
a digital signal processor, coupled with the memory module and the memory controller, respectively, and located on a data transfer route between the memory controller and the memory module, for processing signals outputted from the memory controller according to a work mode that a select code corresponds to.

2. The computer system according to claim 1, wherein the digital signal processor receives an attenuated data signal and the attenuated data signal results from the attenuation of a data signal outputted from the memory controller.

3. The computer system according to claim 2, wherein the digital signal processor recovers the attenuated data signal and transmits the recovered attenuated data signal to the memory module.

4. The computer system according to claim 1, further comprising a south bridge chip, coupled with the memory controller, for setting the select code according to an operating frequency of a central processing unit (CPU) and utilizing the select code to set the work mode of the digital signal processor.

5. The computer system according to claim 4, further comprising a basic input output system, coupled with the south bridge chip, for setting and storing the operating frequency of the CPU.

6. A method for processing a data signal of a memory interface, performed between a memory controller and a memory module, the method for processing the data signal comprising the steps of:
receiving an attenuated data signal, wherein the attenuated data signal results from the attenuation of a data signal outputted from the memory controller;
processing the attenuated data signal according to a work mode to which a select code corresponds to obtain a second data signal; and
transmitting the second data signal to the memory module.

7. The method for processing the data signal according to the claim 6, wherein the select code is relevant to an operating frequency of a CPU.
